(19) United States
(12) Patent Application Publication
(10) Pub. No.: US 2021/0319125 A1
(43) Pub. Date: Oct. 14, 2021

(54) SOFTWARE PROTECTION VIA KEYED RELATIONAL RANDOMIZATION

(71) Applicant: Yongxin Zhou, Mequon, WI (US)

(72) Inventor: Yongxin Zhou, Mequon, WI (US)

(21) Appl. No.: 16/315,635

(22) PCT Filed: Aug. 7, 2017
(86) PCT No.: PCT/US2017/045808

§ 371 Date: Jan. 5, 2019

Related U.S. Application Data
(60) Provisional application No. 62/376,904, filed on Aug. 18, 2016.

(51) Int. Cl. G06F 21/62; G06F 1/28

(52) U.S. Cl. CPC G06F 21/629; G06F 1/28

(57) ABSTRACT

The present invention provides a computing-oriented system and method to protect information flow inside and between software programs via relational randomization using relations over binary strings and their mathematical attributes. While performing the same functionality, a randomized software program is protected because obtaining information of original data or code requires both recognizing systems of power relations and solving relational systems which are mathematically hard and computationally intractable. Randomized relations also secure the data information flow to and from software programs with encryption and decryption keys. Software keys are also generated for the integrity verification of a protected application system. Furthermore, the system and method in this invention generate obfuscated, diversified software programs in a plurality of unified code formats.

### FIELD OF THE INVENTION

The present invention relates generally to information and computer security, and more specially the protection of confidentiality and integrity of data and computer software program, and even more specifically, to systems and methods of program obfuscation, integrity verification (IV) and encryption.

### BACKGROUND OF THE INVENTION

With the accelerating progression of modern computing technology from personal computers to mobile devices to the internet of things (IoT), the demand for information security technology has surged. Nevertheless, existing integrity and confidentiality protection for new computing systems is still insufficient, and the rapidly approaching wave of IoT devices can only make the task even more challenging.

In the prior art of software security, a common approach is data-oriented protection, wherein data transformations are created to safeguard the information flow in a software program. Examples include the data encryption and decryption schemes in Fully Homomorphic Encryption (FHE) as presented in U.S. Pat. No. 9,083,526 and its related patents, and data encoding and decoding methods to generate tamper resistant software programs as presented in U.S. Pat. No. 6,842,862 and its related patents. In these schemes, the focus on data protection can generate imbalanced software protections followed by impractical implementations, as demonstrated in the case of FHE.

Another approach in the prior art is to transform computer languages by employing compiler related techniques and/or their implementation methods on machines. This approach is presented in U.S. Pat. No. 6,668,325 and related patents, U.S. Pat. No. 7,430,670 and related patents, and U.S. Pat. No. 7,757,097. While widely used in practices, the compiler approach provides limited protection due to the lack of computational complexity and/or uniformity in the program produced. In some cases, even existing compiler optimization techniques can sufficiently crack the protection this approach offers.

Thus, there is a need to develop a computing-oriented protection method and system such that complex mathematical relations can be embedded in protected software. Furthermore, these mathematical relations can be randomly selected from large pools of instances that share uniformed code formats to maximize the complexity of produced programs.

### SUMMARY OF THE INVENTION

It is the object of the present invention to provide a novel method and system to advance the prior art solutions of software security and mitigate the disadvantages of these solutions.

In the present invention, relations over relations over binary strings and mathematical characteristics of these relations are utilized in the construction of relational codings, including relational embeddings of a variety of language components of software programs into units, relational associators which are utilized to compose independent language components into a program with the required unit format, and relational layer and cluster coding to create systems of relational equations within a program to randomize its information flow for the protection of the program. Integrity verification keys for a software program and keys for data encryption and decryption are also created.

An embodiment of the present invention comprises a method to safeguard software programs and information flows between them. The method of the embodiment utilizes randomized relational codings and mathematical characteristics of relations over binary strings to transform software programs into their protected form. The information flow in original program is obfuscated in the transformed version, which is in unified code formats or code units, and its confidentiality is protected by keys and the integrity of the transformed software program is verified by IV-keys generated in the transforming process.

Further, in an embodiment according to the present invention a method of protecting software program against specified attack model is provided. Based on the attack module, a set of specified code units is generated. Then relational codings mentioned in Paragraph [0007] are used to generate protected software program effectively against the specified attack.

Further, an embodiment of the present invention provides a method that can produce more than an exponential number of highly diversified copies of a given software program, due to the abound amount of relations that can be used as relational codings. The diversified copies of the same software program generated from this method can be used to meet the requirements of security challenges.

An embodiment of the present invention comprises a method for randomizing information flow of a software program, comprising the following steps: receiving the said program; segmenting the said program into code units; embedding the segmented program into a randomized entropy program in the said code units; building systems of power relational equations in the program; compressing the said composed program; outputting the compressed program and the key, whereby original information of the said received program and entropy information of the said entropy program is randomized and composed into code units such that information flow of received program is obfuscated, diversified and protected.

An embodiment of the present invention comprises a method for randomizing information flow of a software program, comprising the following steps: receiving the said program; segmenting the said program into code units; embedding the segmented program into a randomized entropy program in the said code units; building systems of power relational equations and conditional associators in the program, wherein the mathematical characteristics of relations in and of these equations are collected and represented as IV-keys; compressing the new program; outputting the compressed program and the IV-keys; whereby original information of the said received program and entropy information of the said entropy program is randomized and composed into unified formats such that information flow of received program is obfuscated, diversified and protected, and the said output program performs functionality of the said received program, and the said IV-key can be used for integrity verification of the said output program.

An embodiment of the present invention comprises a method for randomizing information flow of a software program, wherein the information flow is the data information flow to or/and from a program, comprising the following steps: receiving the said program segmenting the said program into code units; embedding the segmented program including data variables at concern into a randomized entropy program in the said code units; building systems of power relational equations and conditional associators in the program, wherein the mathematical characteristics of relations in and of these equations are collected and represented as IV-keys along with encryption or decryption key, or both encryption and encryption keys for the said data information flow; compressing the said composed program; outputting the compressed program, IV-keys, and encryption or decryption keys from the said selected keyed data relational embedding; whereby original information of the said data, the said received program, entropy information of the said entropy program is randomized and composed into unified code formats such that information flow of the said data and the received program is obfuscated, diversified and protected, and the said output program performs functionality of the said input program with encrypted data to or/and from the the said output program, and the said IV-key along with the data encryption or/and decryption key can be used for integrity verification of the said output program and the said data information flow.

Embodiments of the invention also comprise microprocessor readable nontransitory storage media containing executable instructions which when executed cause the data processing system with one or a plurality of microprocessors to perform any one of the methods described herein.

The summary does not include an exhaustive list of all embodiments of the present invention and other embodiments will become apparent to those ordinarily skilled in the art upon review the teaching of the present invention.

### BRIEF DESCRIPTION OF THE DRAWINGS

Embodiments of the present invention are described with reference to the following drawings, wherein

FIG. 0 illustrates a system in which the present invention may be practiced;

FIG. 1 shows a flow chart illustrating an embodiment of a method for relational randomizing of the information flow of a software program;

FIG. 2 shows a flow chart illustrating an embodiment of a method for composing an entropy program with a given software via relational associators;

FIG. 3 shows a flow chart illustrating an embodiment of a method for building systems of relational equations into a given program;

FIG. 4 shows a flow chart illustrating an embodiment of a method for building integrity verification into a randomized program;

FIG. 5 shows a flow chart illustrating another embodiment of a method for building integrity verification into a randomized program;

FIG. 6 shows a flow chart illustrating an embodiment of a method for building integrity verification into a randomized program to protect both data and program in an application;

FIG. 7 is an illustration of an embodiment of a method for generating relational transformations from relational identities according to the present invention.

### DETAILED DESCRIPTION OF THE PRESENT INVENTION

It is the object of the present invention to provide a novel method and system to advance the prior art solutions of software security and mitigate the disadvantages of these solutions.

### Information Flow and Code Shape

In this disclosure, the term software program information flow, or information flow of a software program is used to refer to all information that related to the text code of the software program and the execution of the text code in a processor, or a plurality of processors, and that can be represented by a polynomial time software program. According to this definition, information flow includes data flow, control flow and both static and run-time information obtained by static analysis tools of a compiler and run time debuggers.

In standard compiler technology, Intermediate Representation (IR) is used to facilitate the transformation from high level computing languages to assembly languages. In the present disclosure, IR is also a Turing-complete machine with a Turing complete instruction set in which two's complement and IEEE754 floating point arithmetic are used for the data representation and computation.

In this disclosure, the term code, software program are used interchangeably. We use the term shape of a code to refer to all properties of code that can be defined by standard compiler technology terms, such as ones from Steven Muchnick, Advanced compiler design and implementation, Morgan Kaufmann Publishers, 1997. The shape of a code includes, for example, its number of instructions, types of those instructions, number of labels, its control flow graph, dependency graph, and call graph. Naturally, the static shape of a code is defined by its static entities while dynamic shape is described by the entities for execution time or run time of the code.

### Code Attribute and Characteristics

In this disclosure, an attribute of a code is a mathematical property of the mathematical structures the code resides in. The following are some examples.

An attribute of data can be its bit pattern, its binary number value, its first bit value, and its most significant bit value. Further more, as the same bit string can be regarded as an element of different algebraic structures (such as, Boolean ring, modular ring or finite field, etc.), the bit string can have many different attributes.

When a bit string is regarded as a 2-adic number, an interesting attribute is its 2-adic distance with respect to an integer interval [i, j], which is measured by number of zeros from a specified position i to a position j with i≤j, such as from the least significant bit to its infinity bit position ∞. An attribute of an instruction can be an algebraic property of the algebraic structure the instruction in, such as Boolean algebraic properties of floating-point instructions.

An attribute is computable if it can be represented by a software program in IR. All attributes used in this disclosure are computable ones. A micro attribute is an attribute that can be expressed by a small number of instructions. To create secure code of high quality, we prefer to use a characteristic with micro attributes. Further, most interesting micro attributes are obtained from relations among instructions of IR. Finally, we define a characteristic of a code to be a set of computable mathematical attributes of the code.

### Code Unit

To describe the similarity of a program that is composed of diversified code components, we define a code unit as a set of code and/or data that all its members share the same set of constrains on code shapes and code characteristics. The following are some examples.

unit A: every element has less than 5 instructions and has both integer and floating-point instructions, and with at least one right shift instruction; unit B: every element has less than 8 instructions and all must be integer type instructions, with at least one arithmetic, one bit shift, and one branch instruction; unit C: every element has at least two 32-bit variables x and y such that their 7th bits [x]₆ and [y]₆ having a relation [x]₆·[y]₆=0; unit D: every element has at least 8 variables of the same size with four of them a, b, c and d satisfying a relation a*b=c⊕d at run-time; unit E: every element has at most 2 branch in labels. The unit of a cryptography system, such as RSA or AES, with respect to data security, can be the bit unit {0, 1}.

To manage and organize the software programs belonging to a given set of units, a partial order can be imposed on code units based on the constrains each code unit has. A unit is great than unit B if and only if the constrains of A is a subset of constrains of B.

Recall that a set with a partial order is called a poset. Thus we have a unit poset, a set of units with a partial order. Also recall that a lower bound of a subset A of a poset U is an element u∈U such that u≤a for all a∈A. We will use lower bounds of a subset of a unit poset to find common characteristics of a subset of units.

A software program is said belonging to a code unit if there exists a partition of its data and instruction sequence such that every segment of the partition is a member of the code unit. A software program can have a plurality of ways belonging to a code unit and a software program can belong to a plurality of code units via different partitions. A code unit can own multiple software programs, because code in the unit can be used to form a plurality of software programs.

The homogeneity level of a program that is composed of code components belonging to a set of units is measured by the code size of the program, the units used in the program, the partial relation of the units, number of code segments belonging to each code unit, and other factors (such as number of families of associators (defined in Paragraph [50]) and number of ECS families (defined in Paragraph [56]) in the program) related to the concept of code unit.

Relations Over Relations Over Binary Strings and their Representations

For a given set S, a relation over S is a subset of a Cartesian product Sn=S×S . . . ×S of n copies of S, where n is a natural number. We say a relation over S is computable if there is an IR representation of the relation, that is, the membership of the relation can be computed and determined by a Turing complete machine.

In this invention, we focus on relations about binary strings. Let B={0, 1} be the binary set and let B^{∞}=Uᵢ₌₁^{∞}Bⁱ, where Bⁱ is the set all binary strings of length, or of dimension i. We use R to denote the set of all computable relations over B^{∞}. Naturally, the dimension of a relation in R is the largest dimension of its elements. Based on this concept, each computable Boolean function is a relation in R of dimension 1, and every instruction in the instruction set of IR is a relation of R. Obviously, a 32-bit instruction in R has dimension 32. Although the final result of a 32-bit comparison instruction is in B¹, its dimension is regarded as 32.

To represent and manipulate relations effectively, we define a generating set of a relation set as a subset such that all relations in the set can be obtained through the composition operation over elements of the subset. Obviously, a relation set can have multiple generating sets. Following this concept, the entire instruction set of IR is a generating set of all software programs from the IR.

To represent relations over programs the following concept is necessary. Let Ω be the set of all computable relations over R. Obviously, Ω is a subset of the power set of R. We will refer an element in Ω as a power relation. Note that each individual element of R, as a subset with a single element, can be regarded as an element of Ω. Thus R can be regarded as a subset of Ω.

Based on power relations in Ω we build the method of this invention.

### Software Programs, R and Ω

Note that any function over Bⁿ, including any instruction in IR, is a relation in R, for n=1, 2, . . . . Therefore relations over functions over Bⁿ are in Ω. Also note that all functions over Bⁿ themselves are elements of Ω, which implies Ω has all software programs created from IR. Furthermore, Characteristics of software programs are also elements of Ω, as they are computable mathematical attributes of instructions from IR.

We say a power relation in Ω belongs to a code unit if the power relation has a code representation that belongs to the unit. A characteristics of a power relation in Ω is defined by its code representation: A characteristic of a power relation is a characteristic of a code that represents the power relation. The set of characteristics of a power relation can be big because a software program can have multiple characteristics and a power relation can have multiple code representations.

For a power relation in Ω, there is always a set of basic attributes related to the relation directly, such as the mathematical constrains for a power relation to be the power relation, and probability measurements to indicate when the power relation holds. This set of basic attributes can be characteristics of the code representing the power relation, and by definition, characteristics of the power relation.

In remaining of this disclosure, a power relation in Ω and its IR code representations are used interchangeably unless distinguishing between different representations is needed.

### Operations in Ω

We say an element of Ω as an operation in Ω if the cardinality of the element is greater than 1. Recall that the cardinality of a set is the number of elements in the set. Following this definition, all instructions in IR are operations, so is the composition operation for functions in R. Operations in Ω shall be used to associate relations in Ω.

### A Power Relation Associator in Ω

If a power relation r in Ω can be expressed by a finite set of power relations U={r₁, . . . , rₘ} in Ω linked by a set of operations L in Ω, the 3-tuple (r, U, L) is called a power relation associator, or an associator of Ω. We refer relation r as the root of the associator, and relations in U as leaves of the associator. An associator can be conditional if a condition is imposed on the expression of root.

The family of a set of associators: If a set of associators Family(U) share the same set of power relations U, Family(U) is called an associator family.

Associators are used to form new power relations from given ones. Following the definition, an associator must have a power relation identity of elements from Ω.

The following example shows an associator formed from functions. Consider two functions ƒ(x)=a*x², g(x)=b*x over the set of 32-bit strings B³². The relational identity

g(x)=((((ƒ(x)⊕d⊕g(x))+i)⊕ƒ(x))j)⊕c,

where a=0x662a439a, b=0xb1c55eaƒ, c=0x63ƒ59147, d=0x2e5ƒa47d, e=0x4daa353a, i=0xƒƒƒƒƒƒƒƒ, j=0x00000001, gives us a power relation associator (g(x), U, L), where U={ƒ(x), g(x)} and L={⊕d, ⊕, +i, ⊕e, +j, ⊕c}. Note that in this example, relation g(x) is both a leaf and the root of the associator.

Similarly, more associators can be derived from the given identity.

Extractable Code Sequence (ECS) from a Power Relation

In order to randomize the information flow of a given program, we need many different ways to represent any given language component. The following concept and the mechanisms built on it is a tool for us to achieve the goal.

A segment S in a code sequence of a given power relation P is extractable if the segment S can be represented by the remaining code sequence C and a finite number of other power relations U in Ω linked via relational operations L. S is called as an extractable code sequence or ECS, and P as the host relation of S. Naturally, a characteristic from ECS is called extractable characteristic, or ECS-Char.

As multiple ECSs may come from the same host relation, this set of ECSs is referred as a family of ECSs of the host relation. Also cases my arise that an ECS (and its characteristics) is shared by multiple power relations. Following the definition another observation is that (ECS, {C, U}, L) is a relational associator.

If an ECS of a given power relation P is a data variable, we say the relation P is equipped with an data variable encryption method.

ECS can be obtained from identities of power relations in Ω. Examples are included in Paragraph [97].

### Relational Embedding of a Power Relation Via Relations in Ω

Relational embedding is a relationship between two relations such that a given power relation r, referred as a guest relation is part of the power relational representation of anther power relation s, referred as a host relation.

Obviously, the host relation of an ECS is a relational embedding of the ECS. But the concept here is more general: we may not be able to extract guest relation r out from the host relation s, in terms of representing r by some relations related to s and some relational operations, and the host relation s may not be a super set of guest relation r neither.

For example, based on the definition, we say that the relation 2*x+732423*z+y is a relational embedding of both guest relations x+y and 732423, where x+y can be extracted but 732423 may not be because it depends on the value of z.

A conditional relational embedding is a relational embedding such that only under certain condition or conditions has the host relation a part as the guest relation. For example, the relation (2*x+732423*z+y)*(x+y+1−z) is a relational embedding of the guest relation 2*x under the condition x+y=z. It is worth to mention that the condition of a conditional embedding can be a dynamic one, that is, the condition meets at run-time of the software program where the embedding resides, making it harder to recognize the embedding. Later we will see that these conditions can be candidates of IV-keys.

### Keys of a Software Program

In this disclosure, a characteristic C (a set of mathematical attributes) of a power relation P in Ω is called a key of the relation P with respect to a code representation Pr if Pr performs its functionality if and only if the characteristic C holds in the code Pr. The power relation P is called a keyed power relation with respect to relation key C. Note that characteristic C maybe part of the code representation Pr. A characteristic C that is shared by all power relations of the elements in a unit is called a key of the unit.

When a key of relation is used for the integrity verification purpose, it is referred as an IV-key of the relation. When a key of a relation wherein the relation is binary data is used for the purpose of encryption or decryption, it is referred as a data encryption or decryption key.

Represent key code by data. In some cases, relation keys can be represented by binary data variables or constants. It may happen that keys themselves are constants or data variables, or it may happen that characteristics of the key code can be represented by bit values to indicate the true or false of a key characteristic.

As a key of a software program is a relation itself, the relational compositions of keys and relational compositions of IV-Keys become new keys and new IV-keys of the software program, respectively. A key for software program can be used to authenticate the program because the key is an essential part of the program. The existing public key systems, such as RSA, can be used for the authentication through public networks. An IV-key of a program can be used for its integrity. Also an IV-key of an embedded relation(s) in a program can serve as its software watermark. Furthermore, the relational composition of a key and an IV-key can serve the role as both a key and an IV-key.

Therefore, key(s) and IV-key(s) of a software program with the help of Public Key Infrastructure (PKI) can be used to achieve the main cryptographic goals in networked environment for software programs: confidentiality, integrity, authentication, and non-repudiation, as PKI achieved for data. One possible embodiment is to use PKI to distribute keys and IV-key of a software program. More information on data cryptography can be found in Handbook of applied cryptography by A. Menezes, P. C. van Oorschot, and S. Vanstone, CRC Press, 1997.

Keys from Associators, ECSs and Relational Embeddings

For a given associator (r, U, L), all three components are power relations. Therefore a key can be obtained from the relation r, any relations in the set U, and any of the operations L. A associator key is an attribute of r, U, or L that directly affects the correctness/incorrectness of the associator relation. There can be multiple associator keys from a given associator.

Because ECSs are relations in Ω, characteristics of an ECS, that is, E-Chars, can be keys. A key can also come from the host relation of an ECS, or the conditions of a conditional embedding. After composition with plain code segments, information related to the key is scattered into multiple code segments, making it harder to reveal.

### Entropy Code and Entropy Key

An entropy code is a code with or without constants in it that used to increase the homogeneity level of new code. It is also used to make code meet the requirements of a unit.

Entropy code is mainly created based on the plain text of a computer program and code of power relations in required units. The characteristics of code in the context of where the entropy code is used are also considered in constructing and selecting entropy code.

Entropy code and the computer program where entropy code is used must belong to the same set of units. Further, to make entropy code well mixed into the non-entropy code context, or make non-entropy code well mixed into the entropy code, input variables of entropy code use the input variables or intermediate variables of a non-entropy program.

### Two Hard Problems

The following problems are mathematically and computationally hard to solve:

Problem 1. Determine the equality of any pair of power relations in Ω.

Problem 2. Find out solution(s) of any system of equations of power relations in Ω.

As a sub-problem of Problem 1, determining if any given pair of programs are equal is a hard problem to solve. Particularly, it is even hard to determine if any given pair of instances of 3-SAT are equal. Therefore Problem 1 is hard. Because it needs to determine if two relations are equal, recognizing relations in Ω is hard.

An equation of power relations is an relational identity of a finite set of power relations linked by operations of Ω. Solving a system of power relations is to find a set of relations such that all power relations in the system are satisfied. Note that a multidimensional and multivariate functional system is an example of a system of power relations. Particularly, each instance of 3-SAT problem is a system of power relational equations, or a system of power relations because equality itself is a relation.

Based on the two hard problems we build systems of randomized relations into a randomized software program for its protection. On the other hand, from an adversary's viewpoint, to figure out key information in a program, one likely and possible attack is to build systems of power relations based on the input/output relationships as well as intermediate relationships observed from the victim program and solve these systems, and dismantle the program to get what an adversary wanted. For unprotected or poorly protected program, an adversary may not bother to solve complex systems of relations to break the code.

Note that when a key is a characteristic of a relation, solving a system is even hard because a relation itself can have multiple characteristics with a variety of code representations that can be composed with the key characteristics. That is the case of the present invention.

### Construct Systems of Power Relations Via Relational Layer and Cluster Codings

A protected software program should have a variety of diversified power relational systems embedded and tangled in it while the solutions of these systems are keys to the security of the program, that is, to its integrity and confidentiality.

In the following paragraphs we describe an embodiment of building such systems according to the spirit of the present invention.

A relational layer coding transforms one or multiple individual relations into a keyed unit. That is, all those transformed relations belong to the unit and share the same key. Because of the sharing key, any code representations of such relations occurring in a software program must also have the same key to make the program work. Therefore, the key can be arranged in such a way that it becomes a solution of a system of power relations in the program. A layer coding can be imposed on a software program by relational embeddings, relational associators, and replacement of code segments.

Now we address a method to form system of power relations where relations belong to different units. We define a relational cluster coding as a relational transformation that transforms one or multiple individual relations, referred as a cluster, belonging to different keyed units W into a new keyed unit u as a lower bound unit of the unit poset W∪{u} according to a partial order of the unit poset.

With the existing units W, for each keyed unit, the cluster can form a system of keyed relations according to layer coding, and multiple power relational systems total. As the new keyed unit u is a low bound of the poset, its key can be composed with all keys of W, the composed keys becomes solutions of multiple power relational systems. And this is what we want cluster coding to achieve. Similar to layer coding, a cluster coding can be imposed on a software program by relational embeddings, relational associators, and replacement of code segments.

In addition to the role played in the key composition, the new keyed unit produced from a clustering coding may form a new system of power relations according to a layer coding.

The following are some examples (but are not limited to) of clusters that can be keyed clusters via relational cluster coding: a cluster of global data values; a cluster of branch instructions; a cluster of comparisons; a cluster of input and output data of a function; a cluster of arithmetic instructions; a cluster of load or store instructions; a cluster of single instructions from each BB of a set of BBs; DAGs from a set of BBs.

It is worth to make a few remarks and state an embodiment according to the present invention by letting layer coding and cluster coding play the following different roles in code security.

While any common characteristics of a set of relations can be a key for the set of relations, the keys from a unit have an advantage that it provides an efficient and systematic way to construct secure code. Therefore, we use keyed unit as our basic security block. From this perspective, layer coding can be regarded as a way of building a power relation from a set of given security blocks. Cluster coding is a way of clustering a set of power relations created by layer codings into systems of power relations, where the composed keys from the units are solutions of the systems. In transforming a software program, we may say layer coding works its way horizontally and cluster coding works its way vertically.

To transform the entire software program and cover all its components, the location of key resourcesis an important part in the construction. Here is one approach. For layer coding, keys are characteristics of language components that are local in a transformed program, such as the information of a dependency graph of registers in its basic blocks, while keys designed for a cluster coding can be ones that cross basic blocks and global, such as attributes related to control flow graphs. The relational compositions of keys from both codings make keys of units as the solutions of power relational systems covering both local and global language components. In this way it significantly increases the complexity level of keyed relations involved in the systems.

Utilizing these two types of codings together in a variety of ways, including randomly picking then from a large set of coding libraries we transform given software programs into instances of the two hard problems, namely recognizing the power relational systems and solving the systems, to secure the given program.

Also note that the keys from units can be composed with keys from other resources such as associators, ECS, and relational embeddings to make even larger systems of power relations for adversaries to recognize and work on solutions.

Finally, the measurement of the density of relational equations in a program can be defined as a function of the code size of the program, the number of power relations in the program, the number of systems of power relations in the program, the number of overlapped power relations and other factors related to the set of power relations. Using this measurement as a security indicator, user input options can be made to guide the selection of codings for our relational randomization system to generate a transformed program with the required security level.

### Create Relational Associators, and Embeddings, ECSs, Layer Coding and Cluster Coding Via Power Relational Identities

Based on the definition of a power relation, that is, a relation of some relations over binary strings, power relations can be used to form both layer and cluster codings as longs as they can be represented within the required unit and with suitable keys.

We use an example to show a method that relational identities, a subset of power relations, can be utilized to form ECS, associators, embeddings, and then layer codings and cluster codings. With the following two equal power relations over binary strings x, y, z, u, v∈B^{∞}

r₁(x,y,z,u,v)=x⊕D(2*(z*x*y)²*v)⊕((u∨0x1)*z*x*y)⊕(z*x*y)⊕(2*x²*v)⊕((u∨0x1)*x)

and

r₂(x,y,z,u,v)=(−(x⊕(z*x*y)))⊕(−((2*x²*v)⊕(2*(z*x*y)²*v)⊕((u∨0x1)*x)⊕((u∨0x1)*z*x*y))),

assocaotors, a layer coding, and a clustering coding with the help of coding at Paragraph [0052] can be created.

Associators. Because of the identity, any variable x can be expressed as

x=ƒ(x,y,z,u,v)=(2*(z*x*y)²*v)⊕((uV∨0x1)*z*x*y)⊕(z*x*y)⊕(2*x²*v)⊕((u∨0x1)*x)⊕r₂.

Because the identity is true for all values y, z, u, v, an associator with x as its root and x, y, z, u, v as leaves is produced. Any unrelated instructions of a program can be related by this associator: let x be the value of an instruction, and let u, v, y, z be any other instructions.

Relational embedding and ECS. Because of the identity, several relations can be embedded into it and they are even extractable. For example, relations x, x*y*z, and 2*x²*v are among them.

Layer coding. Because of the identity, a layer coding can be produced. For example, if the unit requirement is a restrain that multiple constants must appear in suitable small expressions, we may assign some constant values to some variables and obtain a keyed layer codings. Let u, v and z be any constant values form B^{∞} and let a key value be key=(u∨0x1)*z, then the set of relations derived from the identity shares the same key and form a layer coding.

For 32-bit instructions, with a constant assignment v=0x662a439a, u=0xb1c55eaƒ, and z=0x5b086ƒ07, we have key=0x9aeb77c9, and the relations become

r₁=x⊕(0xaadc47a*(x*y)²)⊕(key*x*y)⊕(0x5b086ƒ07*x*y)⊕(0x662a439a*x²)⊕(0xb1c55eaƒ*x),

and

r₂=(−(x⊕(0x5b086ƒ07*x*y)))⊕(−((0x662a439a*x²)⊕(0xaadc47a*(x*y)²)⊕(0xb1c55eaƒ*x)⊕(key*x*y))).

Then relations x, x*y and any of the xor terms in the two relations share the same key in the layer coding. Obviously, other keys with other derived relations can be constructed in a similar way.

Cluster coding. Because of the randomness of variables in the two relations r₁ and r₂, cluster coding can be obtained by relating to variables or constants of other relations, such as the one described at Paragraph [0052], to form shared keys in multiple relations cross different units.

### Code Compression and Optimization

After applying certain number of relational codings to a given software program, the transformed program and its data can potentially be compressed or optimized. There are two reasons to do so: the code can be compressed to be more efficient and compact in terms of time and space, and some preferred and predetermined types of relational codings can benefit from the process. An example for the latter case is that constant folding makes it very hard to get back to original constants appearing in original relational codings.

Applicable code optimization techniques from compiler practices can be used in this step, including algebraic expression simplification, dead code removal, eliminating common sub-expressions, loop unrolling, and the previously mentioned constant folding, etc. Because there is no efficient solution could be found for the two hard problems mentioned in the present disclosure, this process can not code back transformed program to its original form. Instead, the process makes code more robust by leaving less clues of the power relations applied and strengthening connected relations in the code.

### Program Protection Against Specified Attacks

An attack to a software program can be described as an attack to some specified information flow of the software application.

For example, code lifting attack happens at the boundary of the information flow of a portion of software; code injection attack relates to particular information flow at some specified locations where the information flow can be isolated from its code context; control flow integrity (CFI) attacks target at the information flow of the Boolean functions of control flow graph that Boolean value modification results into the broken of the integrity; ROP, or return oriented programming attack takes information flow (including specially those address values) at end of return instructions and some specified instructions in an application to form new program at attacker's will; White-Box cryptographic key attack happens in specified location where the information flow related to specified data within specified code context, and so on.

To mitigate these attacks, software program units can be designed against a given attack. For example, the code patterns at the boundary where code lifting attack happens, or where code injection happens, or where a CFI is broken can be the information to design of code units such that keys from the units are ready to be solutions of systems of power relations which involves substantial number of variables to be associated with.

For ROP attacks, units can be designed to make all address computation code diversified statically and dynamically with similar levels of homogeneity as that of surrounding code, and in such a way it is very hard for attacker to figure out a general method to guess the real addresses statically or dynamically. As a result it can not jump to the locations of instructions needed.

Following the same principle, information from the code pattern of a cryptographic key and the code context around can be used to design units such that in the randomized program code these units appear in substantial number of locations even where codes not related to whiteBox key.

Speaking broadly, the following steps can be taken to protect a program against a given attack.

First, an attack module should be built and the attack vector or surface is analyzed. Then based on the analysis code units can be designed. Thirdly, power relational codings specified to the analysis can be designed and created accordingly. Lastly, the system and method described below can be applied to safeguard the program.

### Information Flow Randomization Via Keyed Relations

Randomized information flow of both data and code is a fundamental defense mechanism against attacks to a software program. The remaining of the present disclosure, with the help of block diagrams, gives a detailed description of embodiments of the system and method according to the present invention.

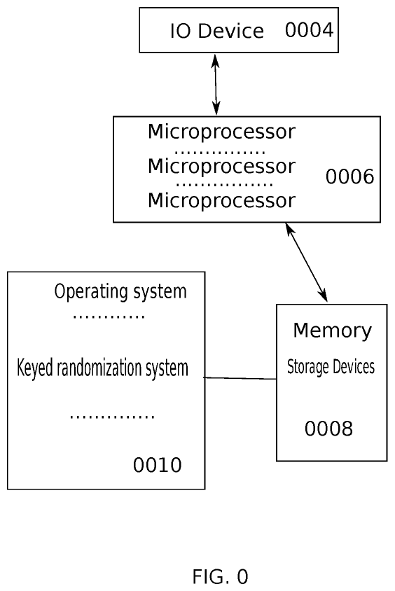

FIG. 0 illustrates an exemplary system in which an embodiment of the present invention may be practiced. Block 0004 is an input-output device of the system that may communicate with outside devices including communication networks. A plurality of microprocessors in block 0006 are connected to memory or memory storage devices in block 008 and execute programs in block 0010 where a keyed randomization program implemented based on the teachings of this invention resides. Single microprocessor system can also be used to practice the present invention.

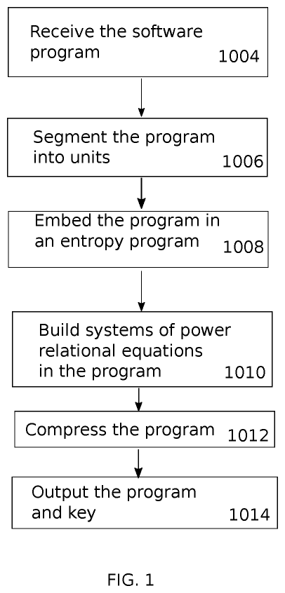

FIG. 1 is a flowchart which shows an embodiment of the information flow randomization process. In block 1004 receive the software program. A preferred format is in an IR that program transformation utilities are well supported, such as the LLVM compiler framework (See www.llvm.org for more information). With that being said, this embodiment does not limit to any specific IR representation, object code, assemble language, or virtual machine, etc, because power relations over binary strings used in this invention work well on all computing platforms. Optionally, also received in this step can be user preferred restrictions in the generation of the randomized program and its key in term of time and space.

In block 1006 segment the said software program into a set of units equipped with a partial order, and unit keys. The assignment of code units to this segmenting step is considered with at least three factors: (a) power relations in the program, (b) the code shape of the program, and (c) the security impact of a unit to the program from a set of units. While the first two factors reflect information from the instructions and their combinations in the program, the third factor provides information to guide the unit selection from a subset of all possible units that the segmentation of the given program can use. The unit poset must guarantee a subset of units for the segmentation of any software program exists in the poset. For this purpose, one possible embodiment of the partial order in a unit poset is that every unit poset always has a unit being the entire instruction set of the IR and the unit has the lowest order. Obviously, the security requirements from user can have an impact on unit selection for the segmentation.

Also in block 1006, the process of selecting keyed units can have another factor to consider: the attack module and specified code format of the victim code, as discussed in Paragraphs [0106] to [0110].

In block 1008 establish a randomized entropy program based on the said subset of keyed code units. In this step, a sequence of code segments picked up randomly from the given subset of code units is generated. Further more, to increase the homogeneity level of transformed program, a set of entropy code and entropy key that are not in the given code units may be created and randomly picked to be part of the entropy program. Note that because these are code segments, values and addresses of variables in the code segments are to be assigned in order to be part of a program.

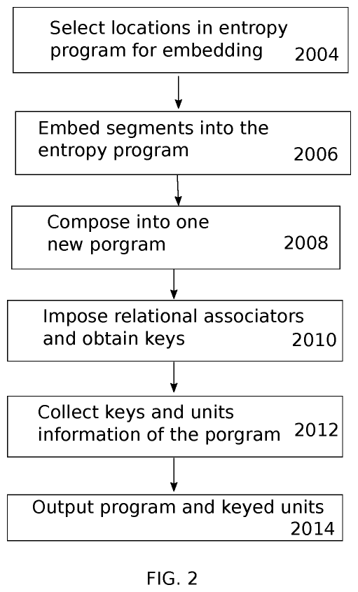

Also in block 1008 compose the entropy program and the said segmented program in the keyed code units, where both conditional and unconditional relational embeddings and relational assocators are applied to the two programs to generate a functional equivalent software program. The flow chart of FIG. 2 shows the composing process.

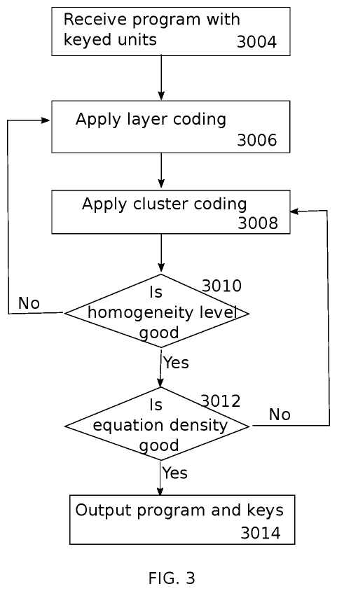

In block 1010 the information flow of the composed program is randomized via systems of power relations of keyed unit code that are imposed in the program. The randomized program preserves the functionality of the said composed program. The flow chart in FIG. 3 shows an embodiment by utilizing relational layer and cluster codings.

In block 1012 compress and optimize the said composed program, as stated in Paragraphs [102] and [103].

In block 1014 output the compressed program and keys, whereby original information of the said received program and entropy information of the said entropy program is randomized and composed into code units such that information flow of received program is obfuscated and protected.

FIG. 2 shows an embodiment according to the present invention of composing the entropy program and the said segmented program in the code units into a functional equivalent program.

In block 2004 code locations in entropy program are selected to embed segments of the segmented program. Based on the units of both programs, the locations in entropy program are selected randomly as long as it keeps the unit code format of the entropy program, and the unit code format of the segmented program in the new program.

In block 2006 embed the segments of the segmented program into entropy program; if the set of units needs to be readjusted, relational embeddings are applied to those segments involved by letting them be the guests of the embedding and let new host codes belong to suitable units, and then embed the host codes into the entropy program. Readjustment may happen when the homogeneity level must be improved to a required level.

In block 2008 compose the two programs into a new program that is functionally equivalent to the segmented program. At this point, the code in the entropy program part is dead code. To join the two together, operands of instructions of the entropy program are set by input variables and some intermediate variables of the segmented program, and new branching instructions are created and insert into the program in order to make the new program functionally equivalent to the segmented program. Note that at end of this step, the new program should compile and function, but if powerful compiler optimization algorithms applied, all entropy code could be removed.

In block 2010 impose relations on the new program via relational associators. For any relational associator, we may choose its root relation from the segmented program and its leaves from the entropy program, or root relation from the segmented program and its leaves from entropy program, or root from the segmented program and leave from both segmented program and entropy program. Then the root relation is replaced by its representation in the associator, and the associator is imposed on the program.

Also in block 2010, with the new relations imposed, the keys of units in the new program can composed with the keys from the associators and the key set of the existing units can be updated. Note that new units and their keys are introduced to the new program by code of imposed associators. Also note that the density and the allocation of associators in the new program can be vary according to security requirements of users. At end of this this step, with sufficient amount of associators and keys in place, it would be very hard for any compiler optimization algorithms to recognize and remove the code that related to the entropy program.

In block 2012 collect the unit information and keys of the units in the new program and adjust their partial order.

In block 2014 output the newly generated program and information of the unit set to block 1010 in FIG. 1

FIG. 3 is a flowchart illustrating a method according to one embodiment of the present invention to randomize information flow via systems of power relations.

In block 3004 receive a software program that is in multiple keyed unit posets. Two types of basic randomization, layer coding and cluster coding, will occur independent of each other.

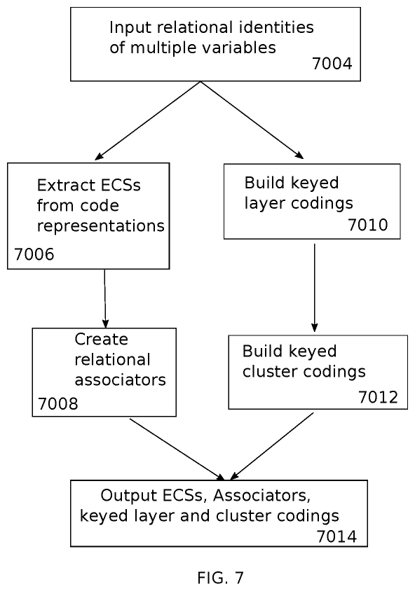

In block 3006 layer coding applied to the software program. First we select a set of relations S from the program; Then we select a layer coding and transform S into a set of relations belonging to a keyed unit; Thirdly, the layer coding is imposed on the software program through the code set S. As a result, the program is keyed with the key from the layer coding and embedded with a system of relations in the program. The information of the unit set of the program is also updated with the new unit. Further more, If any relations in the program already in the keyed unit, layer coding can also be imposed on these relations. In this way, the same key can be used in multiple systems of relations. All layer codings created in FIG. 7 based on relational identities can be used in this step.

Note that in this step relational randomization works in at least three dimensions: (1) a relational set from the program; (2) a layer coding with keyed unit; (3) any set of relational code in the program that belong to the same unit. For each dimension multitude selections can be made.

In block 3008 apply cluster coding to the software program. First we select a subset of units A from the given set of units; Then from the program code select a set of relational code C that belong to A; Thirdly, select a cluster coding to transform C into a keyed unit with key K; Finally, impose the cluster coding to the code C in the program with key K, and compose the key K with the keys in A to form a more secure key. All cluster codings created in FIG. 7 based on relational identities can be used in this step.

Also in block 3008, an alternative embodiment at the third step in the Paragraph [0133] a lower bound of A in the unit poset can be the unit of the cluster coding. That is, key K is the key of the lower bound unit. In this scenario, the composition of K with other keys in A can potentially form more secure code due to the relationships of the characteristics among these units.

Note that in block 3008 relational randomization works in at least three dimensions: (1) a subset of the unit poset; (2) a set of code in program belonging to the subset; (3) a cluster coding with a key. For each dimension multitude options are potentially available to pick.

In block 3010 decide if more layer coding is needed to meet the homogeneity level requirement. If some relational codes in the program have to be coded into a unit a layer coding is applied. Then it is followed by cluster coding step in block 3008, because we want a new system of relations to include the new layer coding.

In block 3012 decide if more cluster coding is needed in order to meet the security requirement of relation or equation density. If so, a cluster coding is imposed on locations where relations are to be keyed into a system and coded into the program.

In block 3014 output the program and its key set information.

### Integrity Verification of Information Flow in a Software Program

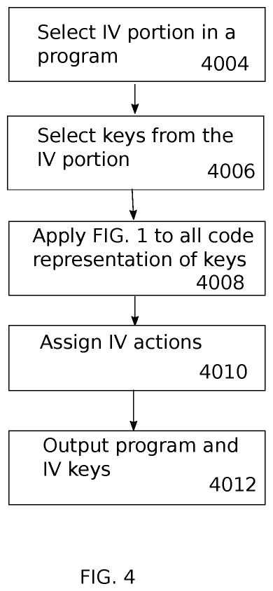

FIG. 4 shows a flow chart of an embodiment of building integrity verifications of a software program via randomized information flow.

In block 4004 select a portion D of a software program P to impose integrity verification. In general, this portion of program is where the application is subject to attacks and set by predetermined attack module. The code portion D can be a segment or multiple segments of the program.

In block 4006 select keys of D. Since D is composed of power relations, D has its own set of keys K, as defined in Paragraph [0063]. The keys should be selected in such a way that each key k E K has an efficient code representation r(k).

In block 4008 apply all steps in FIG. 1 to the code representation r(k) of each k in K, and obtain the output code TK and keys from FIG. 1. The keys are referred as IV-keys.

In block 4010 assign IV-actions. With the given transformed code TK, and the IV-keys, TK can be composed with the computation in P such that a failure of providing the correct IV-keys results into an incorrect result of P, a text message to the application, or any other output information to imply the broken of the integrity of D in P.

Also in block 4010, note that TK is embedded with relational equations with IV-keys as solutions, the composition with P can be obtained by conditional associators with the condition being the correctness of the keyed relational equations. Further protection of this portion of code can be obtained from applying the process in FIG. 1.

Also in block 4010, the said IV-action of the composition of P with TK can emit a text message when the correct IV-keys are provided. In essence, this text message can serve as the software watermark of the software program P. Further protection of this portion of code can be obtained from applying the process in FIG. 1.

In block 4012 output the transformed P and IV-keys K.

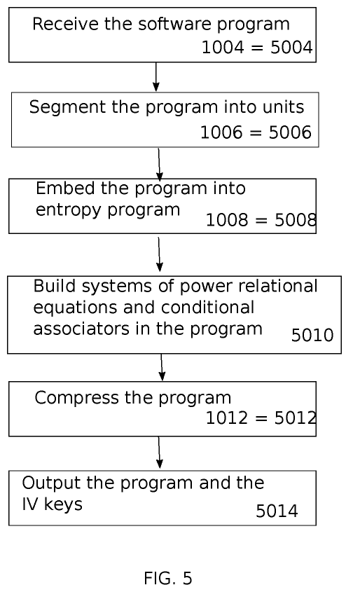

FIG. 5 shows a flow chart of another embodiment of building integrity verifications of a software program via randomized information flow.

In block 5004 receive the said program; In block 5006 segment the said program into code units; In block 5008 embedding the segmented program into a randomized entropy program in the said code units. These blocks are the same as the first three blocks in FIG. 1.

In block 5010 build systems of power relational equations and conditional associators in the program, wherein the mathematical characteristics of relations in and of these equations are collected and represented as IV-keys. In one embodiment, the relational equations can be the conditions of the mentioned conditional associators. That is, in addition to the embodiment in block 1010 in FIG. 1, the relational equations are also used for IV.

In block 5012 compress the new program. This is the same as the block 1012 in FIG. 1.

In block 5014 output the compressed program and the IV-keys; whereby original information of the said received program and entropy information of the said entropy program is randomized and composed into unified formats such that information flow of received program is obfuscated, diversified and protected, and the said output program performs functionality of the said received program, and the said IV-key can be used for integrity verification of the said output program.

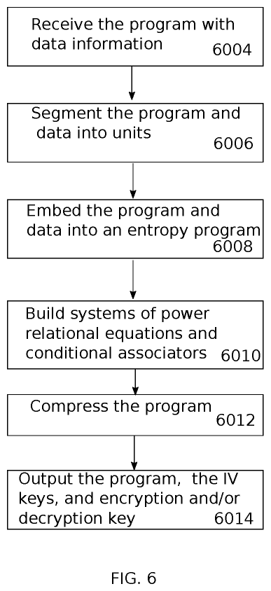

As the protection of information flow of data to and from a program can be regarded as special IV case, the general IV process of program protection can be specialized to focus on data information protection while in a code unit environment, as shown in an embodiment in flow chart of FIG. 6.

In block 6004 receive the said program with data information flow to or/and from a program. Data variables can be any size.

In block 6006 segment the said program and data variables into code units.

In block 6008 embed the segmented program including data variables at concern into a randomized entropy program in the said code units.

In block 6010 build systems of power relational equations and conditional associators in the program, wherein the mathematical characteristics of relations in and of these equations are collected and represented as IV-keys along with encryption or decryption key, or both encryption and encryption keys for the said data information flow.

In block 6012 compress the said composed program, as stated in the Paragraphs [102] and [103].

In block 6014 output the compressed program, IV-keys, and encryption or decryption keys from the said selected keyed data relational embedding; whereby original information of the said data, the said received program, entropy information of the said entropy program is randomized and composed into unified code formats such that information flow of the said data and the received program is obfuscated, diversified and protected, and the said output program performs functionality of the said input program with encrypted data to or/and from the said output program, and the said IV-key along with the data encryption or/and decryption key can be used for integrity verification of the said output program and the said data information flow.

FIG. 7 illustrates an embodiment of a method for generating ECSs, relational associators, keyed layer codings and cluster codings from relational identities according to the present invention.

In block 7004 input power relational identities with multiple binary string variables. The code representation of these relational identities may include branch instructions.

In block 7006 find relations in both sides of the identities that ECSs, and relational embeddings and units can be formed. Depending upon the mathematical attributes of these relational equations, different kinds of ECSs, unit and embeddings can be extracted from the relations and their code representations.

In block 7008 find relational associators from the said identities. ECSs produced from block 7006 are candidates. Possible keys from the associator are collected.

In block 7010 generate keyed layer codings with units. One embodiment is to assign random binary string values to some variables of the identities, and relations among there variables become keys. keyed code units are also constructed in this step. Because of the identities some code components may share the same key.

In block 7012 generate keyed cluster codings. Based on combinations of layer codings generated in the block 7010 and mathematical attributes of relations in the layer codings, keyed cluster codings are generated, as shown in the example in Paragraph [101].

In block 7014 output the generated ECSs, associators, layer codings and cluster codings with their unit and key information.

### RELATED APPLICATIONS

This application claims priority to and the benefit of the filing date of U.S. Provisional Application No. 62/376,904, filed on Aug. 18, 2016 and entitled “SOFTWARE PROTECTION VIA KEYED RELATIONAL RANDOMIZATION”.

### REFERENCES CITED

### U.S. Patent Documents

U.S. Pat. No. 6,668,325 December 2003 Collberg et al
U.S. Pat. No. 6,842,862 January 2005 Chow et al
U.S. Pat. No. 7,430,670 September 2008 Horning et al
U.S. Pat. No. 7,757,097 July 2010 Atallah et al
U.S. Pat. No. 9,083,526 July 2015 Gentry

### Other Publications

L. Dornhoff and F. Hohn, Applied Modern Algebra, MacMillan Publishing Co., 1977.
A. Robert, A Course in p-Adic Analysis, Springer-Verlag, GTM 198, 2000.
A. Menezes, P. C. van Oorschot, and S. Vanstone, Handbook of applied cryptography, CRC Press, 1997.
S. Muchnick, Advanced compiler design and implementation, Morgan Kaufmann Publishers, 1997.
www.llvm.org

What is claimed:

1. A method of protecting the information flow of a software program, the method comprising
a) receiving said software program in an Intermediate Representation format;
b) segmenting said software program into a first unit;
c) establishing an entropy software program belonging to a second unit, with input variables of the entropy software program uninitialized;
d) composing said established entropy software program and said segmented software program into a third unit, comprising
i. selecting a plurality of locations in said established entropy software program;
ii. embedding the segmented software program into said established entropy software program according to said selected locations, with the input variables of said established entropy software program initialized by variables of the said segmented software program, and with needed branching instructions inserted in for the software program to be functionally equivalent to said received software program;
iii. building a plurality of power relations in said embedded software program;
e) compressing said composed software program created in step 1d with software program optimization techniques and thereby creating a protected software program;
f) outputting said protected software program;
whereby the original information flow is randomized and embedded in said protected software program.

2. A method according to claim 1, wherein said Intermediate Representation is LLVM intermediate representation.

3. A method according to claim 1, wherein said second unit in (1c) and said third unit in (1d) are the same unit whose elements are software programs generated from the instruction set of said Intermediate Representation (IR) in 1a and each such a software program has a plurality of constant variables.

4. A method according to claim 3, wherein a key of said unit is a set of randomly selected constant variables from the software programs in said unit which thereby becomes a keyed unit with the said key.

5. A method according to claim 1, wherein said first unit in (1b), said second unit in (1c), and said third unit in (1d) have a partial order such that (the first unit)≤(the second unit)≤(the third unit).

6. A method according to claim 1, wherein said entropy program in 1c is created from randomly selected code sequences of the elements in the second code unit in 1c.

7. A method according to claim 1, step 1(d)i, wherein locations in the entropy program for the embedding are randomly selected from locations that are located between two consecutive elements of said second unit in step 1c.

8. A method according to claim 1, 1(d)iii, building a power relation in a software program in an Intermediate Representation further comprising:
a) creating a relational associator based on the code sequences of said software program;
b) choosing code representation in said software program for the root of said associator;
c) choosing code representation in said software program for the leaves of said associator;
d) generating code representations in said Intermediate Representation for the operations of said associator according to the characteristics of said associator, wherein variables are assigned from random numbers and selected variables of the root and leaves representations;
e) replacing the chosen root code representation in said software program by the code representation of the said power relation associator;
whereby the power relation associator is embedded in the newly created software program which is functionally equivalent to said software program.

9. A method according to claim 8, wherein said relational associator is generated according to the method in claim 13.

10. A computer readable medium storing a program of instructions that, when executed by at least one microprocessor, cause the microprocessor or microprocessors to execute the method of claim 1.

11. A method of protecting the information flow of a software program, the method comprising
a) receiving said software program in an Intermediate Representation format;
b) selecting a plurality of power relations and their corresponding code representations in the said received software program;
c) selecting a layer coding with a keyed unit for said selected power relations;
d) imposing said layer coding of said selected power relations and their code representations on said received software program;
e) outputting the protected software program created in step 11d;
whereby the layer coding is embedded in said protected software program which is functionally equivalent to said received software program.

12. A method according to claim 11, wherein said unit is a set of instructions and each such instruction has one constant operand and the key of said layer coding is a subset of the set of all said constant operands.

13. A method according to claim 11, generating said layer coding from an extractable code sequence (ECS) based on a given relational identity, the method comprising
a) receiving said relational identity and its code representation in an Intermediate Representation format;
b) forming new power relations from relations of both sides of said relational identity;
c) creating an extractable code sequence ECS from said formed power relations;
d) forming a keyed unit from said ECS;
e) outputting said ECS and said keyed unit in said Intermediate Representation format;
whereby said keyed ECS as a keyed layer coding and as a relational associator is generated.

14. A method according to claim 13, wherein said relational identity is formed by two power relations represented in said Intermediate Representation having the same 2-adic distance with respect to an interval [i, j], where i and j are positive integers and i<j.

15. A method according to claim 13, wherein said relational identity in said Intermediate Representation is formed from a matrix identity with a plurality of constant variables over 2-adic numbers.

16. A software system, comprising a program of instructions stored in computer readable memory that, when executed by at least one microprocessor, cause the microprocessor or microprocessors to execute the method of claim 11.

17. A method of protecting the information flow of a software program, the method comprising
a) receiving said software program in an Intermediate Representation format;
b) selecting a plurality of power relations and their corresponding code representations in the said software program;
c) selecting a plurality of layer codings with keyed units for said selected power relations;
d) creating a cluster coding according to said layer codings and their corresponding keyed units;
e) imposing said cluster coding to said received program;
f) outputting the protected software program;
whereby said cluster coding is embedded in said protected software program which is functionally equivalent to said received software program.

18. A software system, comprising a program of instructions stored in computer readable memory that, when executed by at least one microprocessor, cause the microprocessor or microprocessors to execute the method of claim 17.
